(19) United States
(12) Patent Application Publication
(10) Pub. No.: US 2023/0179595 A1
(43) Pub. Date: Jun. 8, 2023

(54) SYSTEMS AND METHODS FOR BIOMETRIC AIDED NETWORK ACCESS CONTROL

(71) Applicant: Fortinet, Inc., Sunnyvale, CA (US)

(72) Inventor: PHILIP R. LONGVAL, SR., Concord, NH (US)

(73) Assignee: Fortinet, Inc., Sunnyvale, CA (US)

(21) Appl. No.: 17/540,867

(22) Filed: Dec. 2, 2021

(51) Int. Cl. G06F 16/24

(52) U.S. Cl. CPC H04L 63/0861; H04L 63/083; G06F 16/24

(57) ABSTRACT

Various embodiments discussed generally relate to network security, and more particularly to systems and methods for using biometric data to enhance security in network access authorization.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2021, Fortinet, Inc.

### FIELD

Embodiments discussed generally relate to providing enhanced security in network access authorization, and more particularly to systems and methods for using biometric data to enhance security in network access authorization.

### BACKGROUND

In a typical network configuration a network security device is relied upon to reduce the possibility of attacks on the network and devices and applications within the network. In many cases, access to resources on a network guarded by the network security appliance is based upon presenting the appropriate username and password. When such username and password combinations become compromised, it is possible for illicit access to the network to be achieved.

Thus, there exists a need in the art for more advanced approaches, devices and systems for authorizing network access.

### SUMMARY

Various embodiments discussed generally relate to providing enhanced security in network access authorization, and more particularly to systems and methods for using biometric data to enhance security in network access authorization.

This summary provides only a general outline of some embodiments. Many other objects, features, advantages and other embodiments will become more fully apparent from the following detailed description, the appended claims and the accompanying drawings and figures.

### BRIEF DESCRIPTION OF THE DRAWINGS

A further understanding of the various embodiments may be realized by reference to the figures which are described in remaining portions of the specification. In the figures, similar reference numerals are used throughout several drawings to refer to similar components. In some instances, a sub-label consisting of a lower-case letter is associated with a reference numeral to denote one of multiple similar components. When reference is made to a reference numeral without specification to an existing sub-label, it is intended to refer to all such multiple similar components.

FIGS. 1A-1D illustrate a collection of interoperable networks each communicably connected to a cloud including a cloud based malicious behavior mitigation system callable by one or more applications each including embedded security calls designed to provide security functions via an API of the cloud based malicious behavior mitigation system in accordance with some embodiments;

FIG. 2 is a flow diagram showing a method in accordance with some embodiments for initializing a three part authentication including biometric information on a network security appliance;

FIG. 3 is a flow diagram showing a method in accordance with various embodiments for initializing a three part authentication including biometric information on an accessing network element;

FIG. 4 is a flow diagram showing a method in accordance with some embodiments for authorizing network access by a network security appliance using a three part authentication including biometric information;

FIG. 5 is a flow diagram showing a method in accordance with some embodiments for performing network access by an accessing network element using a three part authentication including biometric information; and

FIG. 6 is a flow diagram showing a method in accordance with some embodiments for two tiered network authorization by a network security appliance using a three part authentication including biometric information.

### DETAILED DESCRIPTION

Various embodiments discussed generally relate to systems and methods for using biometric data to enhance security in network access authorization.

Currently access to a given network is typically granted based upon presentation of an appropriate username and password. In some cases, second factor authentication has been used where, for example, an email or text message is sent to an individual that presented an appropriate username and password, and the contents of that text message are presented to the network before access is granted. Such a use of second factor authentication has enhanced security in network access authorization. Embodiments discussed herein add a biometric factor required to grant authorization to the network, or at least to grant authorization to one part of the network.

Embodiments of the present disclosure include various processes, which will be described below. The processes may be performed by hardware components or may be embodied in machine-executable instructions, which may be used to cause a general-purpose or special-purpose processor programmed with the instructions to perform the steps. Alternatively, processes may be performed by a combination of hardware, software, firmware and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

In the following description, numerous specific details are set forth in order to provide a thorough understanding of embodiments of the present disclosure. It will be apparent to one skilled in the art that embodiments of the present disclosure may be practiced without some of these specific details.

### Terminology

Brief definitions of terms used throughout this application are given below.

The terms “connected” or “coupled” and related terms, unless clearly stated to the contrary, are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

As used herein, a “network appliance” or a “network device” generally refers to a device or appliance in virtual or physical form that is operable to perform one or more network functions. In some cases, a network appliance may be a database, a network server, or the like. Some network devices may be implemented as general-purpose computers or servers with appropriate software operable to perform the one or more network functions. Other network devices may also include custom hardware (e.g., one or more custom Application-Specific Integrated Circuits (ASICs)). Based upon the disclosure provided herein, one of ordinary skill in the art will recognize a variety of network appliances that may be used in relation to different embodiments. In some cases, a network appliance may be a “network security appliance” or a network security device” that may reside within the particular network that it is protecting or network security may be provided as a service with the network security device residing in the cloud. For example, while there are differences among network security device vendors, network security devices may be classified in three general performance categories, including entry-level, mid-range, and high-end network security devices. Each category may use different types and forms of central processing units (CPUs), network processors (NPs), and content processors (CPs). NPs may be used to accelerate traffic by offloading network traffic from the main processor. CPs may be used for security functions, such as flow-based inspection and encryption. Entry-level network security devices may include a CPU and no co-processors or a system-on-a-chip (SoC) processor that combines a CPU, a CP and an NP. Mid-range network security devices may include a multi-core CPU, a separate NP Application-Specific Integrated Circuits (ASIC), and a separate CP ASIC. At the high-end, network security devices may have multiple NPs and/or multiple CPs. A network security device is typically associated with a particular network (e.g., a private enterprise network) on behalf of which it provides the one or more security functions. Non-limiting examples of security functions include authentication, next-generation firewall protection, antivirus scanning, content filtering, data privacy protection, web filtering, network traffic inspection (e.g., secure sockets layer (SSL) or Transport Layer Security (TLS) inspection), intrusion prevention, intrusion detection, denial of service attack (DoS) detection and mitigation, encryption (e.g., Internet Protocol Secure (IPSec), TLS, SSL), application control, Voice over Internet Protocol (VoIP) support, Virtual Private Networking (VPN), data leak prevention (DLP), antispam, antispyware, logging, reputation-based protections, event correlation, network access control, vulnerability management, and the like. Such security functions may be deployed individually as part of a point solution or in various combinations in the form of a unified threat management (UTM) solution. Non-limiting examples of network security appliances/devices include network gateways, VPN appliances/gateways, UTM appliances (e.g., the FORTIGATE family of network security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), network access control appliances (e.g., FORTINAC family of network access control appliances), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name System (DNS) appliances (e.g., FORTIDNS family of DNS appliances), wireless security appliances (e.g., FORTIWIFI family of wireless security gateways), virtual or physical sandboxing appliances (e.g., FORTISANDBOX family of security appliances), and DoS attack detection appliances (e.g., the FORTIDDOS family of DoS attack detection and mitigation appliances).

As used herein, the phrase “network element” generally refers to any element that is accessible via computer network. Such elements may include, but are not limited to, a network appliance, a network device, a computing devices, an Internet of Things (“IoT”) device, and/or network accessible application. Based upon the disclosure provided herein, one of ordinary skill in the art will recognize a variety of network elements that may be used in relation to different embodiments discussed herein.

As used herein, the phrase “network resources” is used in its broadest sense to mean any resource accessible within a network that is associated with one or more Internet Protocol (IP) addresses. Based upon the disclosure provided herein, one of ordinary skill in the art will recognize a variety of network resources that may be used in relation to different embodiments.

The phrase “processing resource” is used in its broadest sense to mean one or more processors capable of executing instructions. Such processors may be distributed within a network environment or may be co-located within a single network appliance. Based upon the disclosure provided herein, one of ordinary skill in the art will recognize a variety of processing resources that may be used in relation to different embodiments.

Some embodiments provide methods for biometric based network access authorization. Such methods include: receiving, by a processing resource, a first network authentication factor from a network element; comparing, by the processing resource, the first network authentication factor with a first factor; requesting, by the processing resource, a second network authentication factor based at least in part on the first network authentication factor matching the first factor; requesting, by the processing resource, from the network element a biometric network authentication factor; comparing, by the processing resource, the biometric network authentication factor with a second factor; and granting, by the processing resource, access to a network associated with the processing resource based at least in part on a match between the biometric network authentication factor and the second factor.

In some instances of the aforementioned embodiments, the biometric authentication factor is a first biometric data from a user of the network element, and the first biometric data is one or more of: a retinal scan, a face image, a finger print, a cardiac rhythm, a hand print, a foot print, and/or a voice recording. The second factor is a second biometric data previously provided by the user or the network element. The second biometric data is one or more of: a retinal scan, a face image, a finger print, a cardiac rhythm, a hand print, a foot print, and a voice recording. In various instances of the aforementioned embodiments, the first network authentication factor is a username and password corresponding to a user of the network element.

In various instances of the aforementioned embodiments, the second network authentication factor is a response to a question, and the methods further include comparing, by the processing resource, the response to the question to a previously obtained response to the question. In such instances, requesting from the network element the biometric network authentication factor is based at least in part on a match between the response to the question and the previously obtained response to the question.

In some instances of the aforementioned embodiments, the second network authentication factor is a side channel associated with the user of the network element, and requesting the second network authentication factor includes providing a query to the user via the side channel. In such instances, the methods further include comparing, by the processing resource, a response to the query with an expected response. Requesting from the network element the biometric network authentication factor is based at least in part on a match between the response to the query and the expected response. In some cases, the side channel includes an email of the user, or a phone number of the user.

Other embodiments provide computer readable media having stored therein instructions that when executed by a processing resource cause the processing resource to: receive a first network authentication factor from a network element; compare the first network authentication factor with a first factor; request a second network authentication factor based at least in part on the first network authentication factor matching the first factor; request from the network element a biometric network authentication factor; compare the biometric network authentication factor with a second factor; and grant access to a network associated with the processing resource based at least in part on a match between the biometric network authentication factor and the second factor.

Yet other embodiments provide network security appliances including a processing resource, and a non-transitory computer-readable medium coupled to the processing resource. The non-transitory computer-readable medium has stored therein instructions that when executed by the processing resource cause the processing resource to: receive a first network authentication factor from a network element; compare the first network authentication factor with a first factor; request a second network authentication factor based at least in part on the first network authentication factor matching the first factor; request from the network element a biometric network authentication factor; compare the biometric network authentication factor with a second factor; and grant access to a network associated with the processing resource based at least in part on a match between the biometric network authentication factor and the second factor.

Example embodiments will now be described more fully hereinafter with reference to the accompanying drawings, in which exemplary embodiments are shown. This disclosure may, however, be embodied in many different forms and should not be construed as limited to the embodiments set forth herein. It will be appreciated by those of ordinary skill in the art that the diagrams, schematics, illustrations, and the like represent conceptual views or processes illustrating systems and methods embodying various aspects of the present disclosure. The functions of the various elements shown in the figures may be provided through the use of dedicated hardware as well as hardware capable of executing associated software and their functions may be carried out through the operation of program logic, through dedicated logic, through the interaction of program control and dedicated logic.

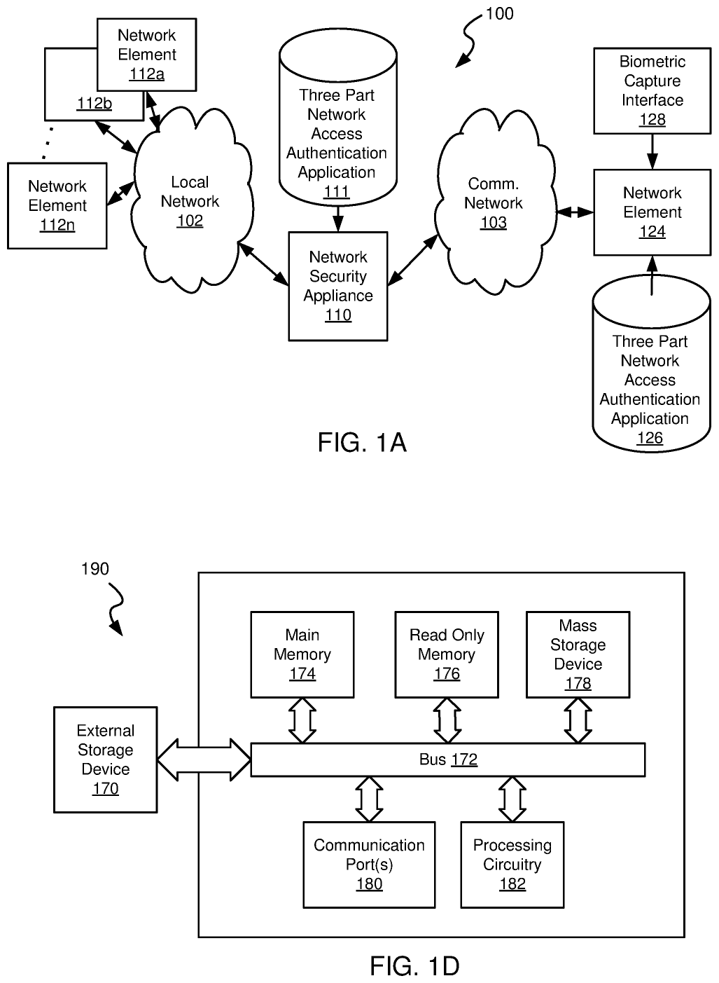

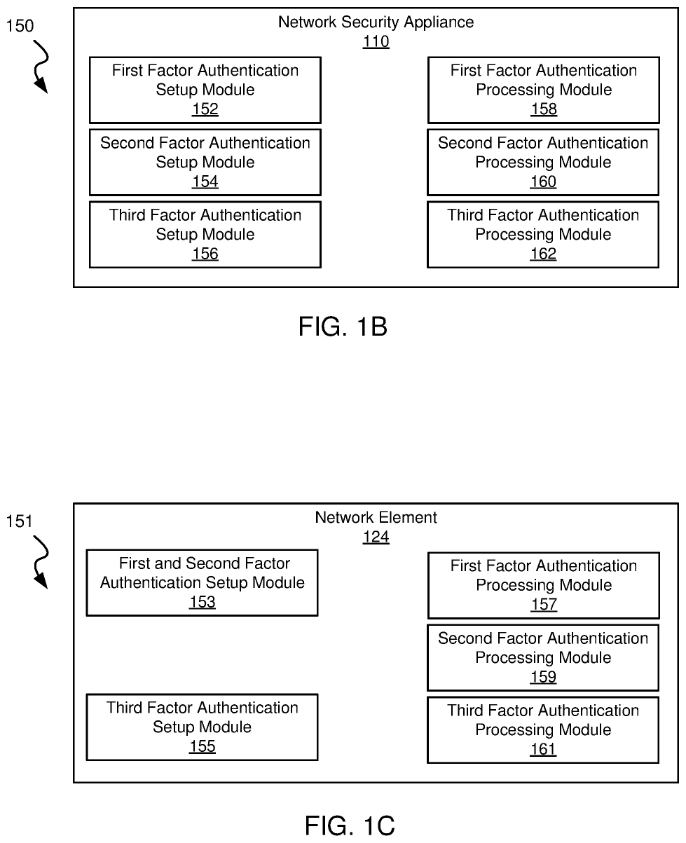

Turning to FIG. 1A, a collection of interoperable networks (i.e., local network 102, and communication network 103) each communicably connect a number of network devices. In particular, access to local network 102 is controlled by a network security appliance 110 communicably coupled to a computer readable medium 111 including a three part network access authentication application. The three part network access authentication application, when executed by network security appliance 110, performs network access authentication based at least in part on a biometric information provided from a device requesting access to local network 102. In addition to network security appliance 110, local network 102 includes a number of network elements 112 (i.e., a network element 112a, network element 112b, and network element 112n).

Local network 102 and communication network 103 each may be any type of communication network known in the art. Those skilled in the art will appreciate that any of the aforementioned networks can be a wireless network, a wired network or a combination thereof that can be implemented as one of the various types of networks, such as an Intranet, a Local Area Network (LAN), a Wide Area Network (WAN), an Internet, and the like.

A network element 124 outside of local network 102 is communicably coupled to network security appliance 110 via a communication network 103. Network element 124 is coupled to a computer readable medium 128 including a three part network access authentication application. The three part network access authentication application, when executed by network element 124, performs in concert with network security appliance 110 to provide a network access authentication based at least in part on a biometric information provided by a user via a biometric capture interface 128. Such biometric information may include, but is not limited to, a retinal scan information, a face image, a finger print, a cardiac rhythm information, a hand print, a foot print, a voice recording, or the like. Based upon the disclosure provided herein, one of ordinary skill in the art will recognize a variety of biometric information that may be used in relation to different embodiments and/or a variety of user interfaces that may be used to capture such biometric information and provide it to network element 124.

Turning to FIG. 1B, a block diagram 150 shows an example implementation of the combination of network security appliance 110 and computer readable medium 111 including the three part network access authentication application. As shown, example network application appliance 110 executing the three part network access authentication application includes a first factor network authentication setup module 152, a second factor authentication setup module 154, a third factor authentication setup module 156, a first factor network authentication processing module 158, a second factor authentication processing module 160, and a third factor authentication processing module 162.

First factor network authentication setup module 152 is configured to receive an initial first factor network authentication from, for example, a network administrator overseeing a network protected by network security appliance 110. In some embodiments, this initial first factor network authentication is a username and a temporary password assigned to a user that will be authorized to access a network protected by the network security appliance. Based upon the disclosure provided herein, one of ordinary skill in the art will recognize a variety of other authentication factors that may be used as the first factor network authentication. The initial first factor network authentication is provided to the aforementioned user.

In addition, upon an access to the network security appliance using the initial first network authentication factor, first factor network authentication setup module 152 is configured to request that the user update the initial first factor network authentication via network element 124. For example, where the initial first factor network authentication included a temporary password, the network security appliance causes a message to be displayed to the user on the network element being used by the user to access the network protected by the network security appliance asking the user to change the temporary password to a password of their choosing. Once requested, first factor network authentication setup module 152 awaits receipt of the modified first factor network authentication from network element 124. Once first factor network authentication setup module 152 receives the modified first factor network authentication from the user via network element 124, first factor network authentication setup module 152 stores the updated first factor network authentication. This updated first factor network authentication then becomes the basis by which the network security appliance will authorize network access in the future.

Second factor authentication setup module 154 is configured to request that the user provide a second factor network authentication by causing a message to display in network element 124. In some embodiments, the second factor network authentication includes a side channel authentication. For example, the side channel authentication can be an email address or phone number accessible to the user, and where the user can receive a message. This second factor network authentication allows the network security appliance to send a message to the user by the defined second factor authentication, and in turn the user can respond to a request to indicate the received message to the network security appliance. As another example, the second factor network authentication may be biometric information personal to the user. Such biometric information may include, but is not limited to, a retinal scan information, a face image, a finger print, a cardiac rhythm information, a hand print, a foot print, a voice recording, or the like. Once requested, second factor authentication setup module 154 awaits receipt of the second factor network authentication from the user via network element 124. Once second factor authentication setup module 154 receives the second factor network authentication, second factor authentication setup module 154 stores the second factor network authentication. This second factor network authentication then becomes the basis by which the network security appliance will authorize network access in the future.

Third factor authentication setup module 156 is configured to request that the user provide a third factor network authentication by causing a message to display in network element 124. In some embodiments where the second factor network authentication was a side channel authentication, the third factor authentication is biometric information personal to the user. In other embodiments where the second factor network authentication was biometric information personal to the user, the third factor authentication is a side channel authentication. Once requested, third factor authentication setup module 156 awaits receipt of the second factor network authentication. Once third factor authentication setup module 156 receives the third factor network authentication from the user via network element 124, third factor authentication setup module 156 stores the third factor network authentication. This third factor network authentication then becomes the basis by which the network security appliance will authorize network access in the future.

First factor network authentication processing module 158 is configured to determine whether it has received a first network authentication factor in the form of a username and password as part of a request for authorization to access a network protected by network security appliance 110. Where the username and password has been received, first factor network authentication processing module 158 compares the received username and password with those stored in a database maintained in relation to network security appliance 110 to determine a match. Where no match is found to the received username and password, network access is not authorized and first factor network authentication processing module 158 provides a message or other indication signifying that access is denied. Alternatively, where first factor network authentication processing module 158 finds a match to the provided username and password, network access is authorized.

Second factor authentication processing module 160 is configured to identify a second network authentication factor associated with an authorized username and password that was recently received and processed by first factor network authentication processing module 158. This identification of the second network authentication factor may include accessing a database maintained in relation to network security appliance 110 to find the second network authentication factor that is stored in relation to the aforementioned username and password. In some embodiments the second network authentication factor is a side channel authentication. As an example, the side channel authentication used as the second network authentication factor can be an email address or phone number accessible to the user, and where the user can receive a message. Second factor authentication processing module 160 uses the identified second network authentication factor (i.e., the identified side channel) to send a message to the identified side channel as part of performing second factor authentication. In turn, second factor authentication processing module 160 awaits a response to the message sent to the identified side channel (e.g., a token included in the message that was sent to the side channel). Once received, second factor authentication processing module 160 determines whether the received input matches that required by the message that was sent to determine whether access will be authorized. Where the received response input is not correct network access is not authorized, second factor authentication processing module 160 provides an indication that network access is denied. Such denial of access may include, but is not limited to, communicating an access denial to a network element that provided the username and password.

Third factor authentication processing module 162 is configured to request biometric information from the user via network element 124 based upon first and second network factor authentication success (as reported by first factor network authentication processing module 158 and second factor authentication processing module 160). Third factor authentication processing module 162 awaits transfer of the requested biometric information from the user via network element 124. Such biometric information may include, but is not limited to, a retinal scan information, a face image, a finger print, a cardiac rhythm information, a hand print, a foot print, a voice recording, or the like. Based upon the disclosure provided herein, one of ordinary skill in the art will recognize a variety of biometric information that may be used in relation to different embodiments.

Third factor authentication processing module 162 compares the received biometric information with that accessed from a database maintained in relation to network security appliance 110. In some cases, sample biometric information was collected during an initiation processed and stored in the database in relation to the username and password for the same individual. This comparison biometric information can be later retrieved from the database and compared with the newly received biometric information to determine if network access is to be authorized. Where no match is found between the comparison biometric information and the newly received biometric information and therefore network access is not authorized, third factor authentication processing module 162 provides an indication that network access is denied. Such denial of access may include, but is not limited to, communicating an access denial to a network element that provided the username and password. Alternatively, where a match is found between the comparison biometric information and the newly received biometric information and therefore network access is authorized, third factor authentication processing module 162 grants access to the network protected by network security appliance 110.

Turning to FIG. 1C, a block diagram 151 shows an example implementation of the combination of network element 124 and computer readable medium 126 including the three part network access authentication application. As shown, example network element 124 executing the three part network access authentication application includes a first and second factor authentication setup module 153, a third factor authentication setup module 155, a first factor network authentication processing module 157, a second factor authentication processing module 159, and a third factor authentication processing module 161.

First and second factor authentication setup module 153 is configured to receive a request from a user to access a network. The request includes an initial first network authentication factor, which first and second factor authentication setup module 153 passes along from network element 124 to network security appliance 110. In some embodiments, this initial first factor network authentication is a username and a temporary password assigned to a user by a network administrator overseeing the network. Based upon the disclosure provided herein, one of ordinary skill in the art will recognize a variety of other authentication factors that may be used as the first factor network authentication. The initial first factor network authentication is provided to the aforementioned user.

Having provided the initial first factor network authentication from network element 124 to network appliance 110 protecting local network 102, first and second factor authentication setup module 153 awaits a response from network security appliance 110. Where network security appliance 110 provides a response granting access to network 102 (i.e., a login success), first and second factor authentication setup module 153 determines whether network security appliance 110 has requested a modification to the initial first network authentication factor. Where a request to modify the initial first network authentication factor had been received, first and second factor authentication setup module 153 prompts the user to update the initial first network authentication factor. Where, for example, the initial first network authentication factor is a username and a temporary password, the user may be prompted to select a password of their choosing. Once the updated first network authentication factor is received, first and second factor authentication setup module 153 communicates the updated first network authentication factor from network element 124 to network security appliance 110. This updated first factor network authentication then becomes the basis by which the user will access the network via the network security appliance in the future.

First and second factor authentication setup module 153 determines whether a request for a second network authentication factor has been received from network security appliance 110. Where such a request has been received, first and second factor authentication setup module 153 prompts the user to provide a second network authentication factor. In some embodiments, the second factor network authentication includes a side channel authentication. For example, the side channel authentication can be an email address or phone number accessible to the user, and where the user can receive a message. This second factor network authentication allows the network security appliance to send a message to the user by the defined second factor authentication, and in turn the user can respond to a request to indicate the received message to the network security appliance. As another example, the second factor network authentication may be biometric information personal to the user. Such biometric information may include, but is not limited to, a retinal scan information, a face image, a finger print, a cardiac rhythm information, a hand print, a foot print, a voice recording, or the like.

Once requested, first and second factor authentication setup module 153 awaits receipt of the second factor network authentication from the user. Where the second network authentication factor is a side channel authentication, the user selects the side channel information via a user input interfaced associated with the network element. Alternatively, where the second network authentication factor is biometric information, the user provides the biometric information via a biometric information interface communicably coupled to the network element. Once first and second factor authentication setup module 153 receives the second factor network authentication, first and second factor authentication setup module 153 provides the second network authentication factor received from the user to network security appliance 110. This second factor network authentication then becomes the basis by which the user will access the network via the network security appliance in the future.

Third factor authentication setup module 155 is configured to determine if a request for a third network authentication factor has been received from a network security appliance 110. Where such a request has been received, third factor authentication setup module 155 prompts the user of network element 124 to provide a third network authentication factor. In some embodiments where the second factor network authentication was a side channel authentication, the third factor authentication is biometric information personal to the user. In other embodiments where the second factor network authentication was biometric information personal to the user, the third factor authentication is a side channel authentication. Once prompted, third factor authentication setup module 155 awaits receipt of the third factor network authentication from the user.

Once third factor authentication setup module 155 receives the third factor network authentication, third factor authentication setup module 155 provides the received third factor network authentication to network security appliance 110. This third factor network authentication then becomes the basis by which the user will access the network via the network security appliance in the future.

First factor network authentication processing module 157 is configured to determine whether it has received a first network authentication factor in the form of a username and password as part of a request for authorization to access a network protected by network security appliance 110. Where the username and password has been received, first factor network authentication processing module 157 forwards the received username and password to network security appliance 110.

Second factor authentication processing module 159 is configured to present a request for information sent by network security appliance 110 to a user via a side channel, and to receive input from a user corresponding to the message sent by network security appliance to the user via a side channel. Second factor authentication processing module 159 forwards the input received from the user to network security appliance 110.

Third factor authentication processing module 161 is configured to determine whether a request for a third network authentication factor has been received from network appliance 110. Where a request has been received, third factor authentication processing module 161 prompts the user to enter requested biometric information. Such biometric information may include, but is not limited to, a retinal scan information, a face image, a finger print, a cardiac rhythm information, a hand print, a foot print, a voice recording, or the like. Based upon the disclosure provided herein, one of ordinary skill in the art will recognize a variety of biometric information that may be used in relation to different embodiments. The user enters the requested biometric information using biometric capture interface 128.

Once the biometric information is received from the user, third factor authentication processing module 161 provides the received biometric information to network security appliance 110. Third factor authentication processing module 161 awaits an indication as to whether network security appliance 110 granted network access based upon the provided biometric information.

Turning to FIG. 1D, an example computer system 190 is shown in which or with which embodiments of the present disclosure may be utilized. As shown in FIG. 1D, computer system 190 includes an external storage device 170, a bus 172, a main memory 174, a read-only memory 176, a mass storage device 178, one or more communication ports 180, and one or more processing resources (e.g., processing circuitry 182). In one embodiment, computer system 190 may represent some portion of a computer, network element 112, 124, or network security appliance 110.

Those skilled in the art will appreciate that computer system 190 may include more than one processing resource 182 and communication port 180. Non-limiting examples of processing resources include, but are not limited to, Intel Quad-Core, Intel i3, Intel i5, Intel i7, Apple M1, AMD Ryzen, or AMD® Opteron® or Athlon MP® processor(s), Motorola® lines of processors, FortiSOC™ system on chip processors or other future processors. Processors 182 may include various modules associated with embodiments of the present disclosure.

Communication port 180 can be any of an RS-232 port for use with a modem-based dialup connection, a 10/100 Ethernet port, a Gigabit, 10 Gigabit, 25G, 40G, and 100G port using copper or fiber, a serial port, a parallel port, or other existing or future ports. Communication port 760 may be chosen depending on a network, such as a Local Area Network (LAN), Wide Area Network (WAN), or any network to which the computer system connects.

Memory 174 can be Random Access Memory (RAM), or any other dynamic storage device commonly known in the art. Read only memory 176 can be any static storage device(s) e.g., but not limited to, a Programmable Read Only Memory (PROM) chips for storing static information e.g. start-up or BIOS instructions for the processing resource.

Mass storage 178 may be any current or future mass storage solution, which can be used to store information and/or instructions. Non-limiting examples of mass storage solutions include Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1300), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 172 communicatively couples processing resource(s) with the other memory, storage and communication blocks. Bus 172 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processing resources to software system.

Optionally, operator and administrative interfaces, e.g., a display, keyboard, and a cursor control device, may also be coupled to bus 172 to support direct operator interaction with the computer system. Other operator and administrative interfaces can be provided through network connections connected through communication port 180. External storage device 190 can be any kind of external hard-drives, floppy drives, IOMEGA® Zip Drives, Compact Disc-Read Only Memory (CD-ROM), Compact Disc-Rewritable (CD-RW), Digital Video Disk-Read Only Memory (DVD-ROM). Components described above are meant only to show various possibilities. In no way should the aforementioned example computer system limit the scope of the present disclosure.

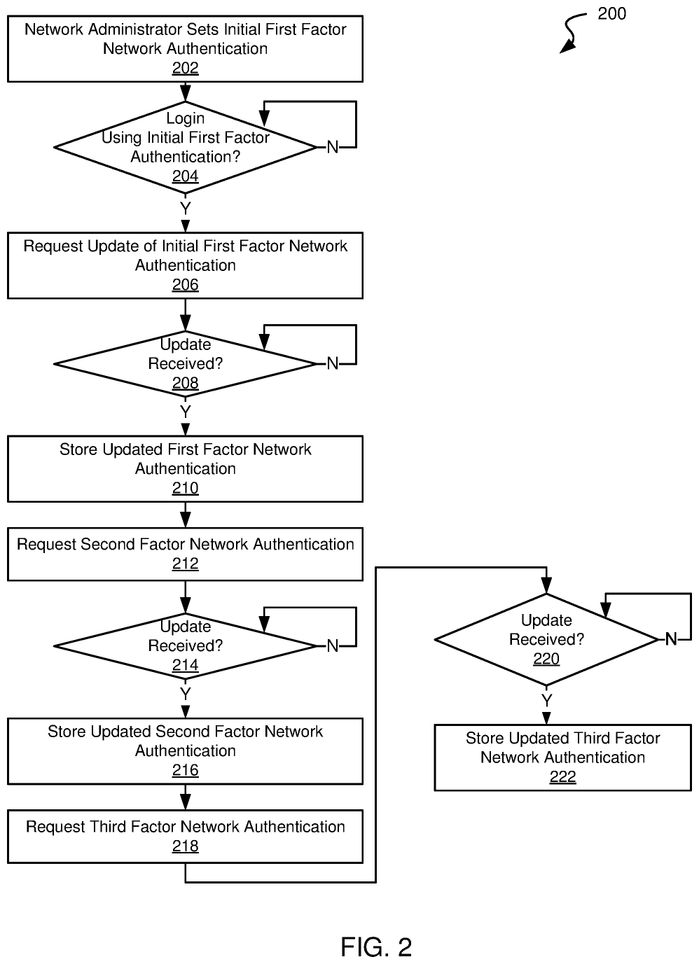

Turning to FIG. 2, a flow diagram 200 shows a method in accordance with some embodiments for initializing a three part authentication including biometric information on a network security appliance. Following flow diagram 200, a network administrator overseeing a network security appliance sets an initial first factor network authentication (block 202). In some embodiments, this initial first factor network authentication is a username and a temporary password assigned to a user that will be authorized to access a network protected by the network security appliance. Based upon the disclosure provided herein, one of ordinary skill in the art will recognize a variety of other authentication factors that may be used as the first factor network authentication. The initial first factor network authentication is provided to the aforementioned user.

Once the network security appliance receives the initial first factor network authentication from a network element used by the aforementioned user in an attempt to access the network protected by the network security appliance (block 204), the network security appliance requests that the user update the initial first factor network authentication (block 206). For example, where the initial first factor network authentication included a temporary password, the network security appliance causes a message to be displayed to the user on the network element being used by the user to access the network protected by the network security appliance asking the user to change the temporary password to a password of their choosing. Once requested (block 206), the network security appliance awaits receipt of the modified first factor network authentication (block 208).

Once the network security appliance receives the modified first factor network authentication (block 208), the network security appliance stores the updated first factor network authentication (block 210). This updated first factor network authentication then becomes the basis by which the network security appliance will authorize network access in the future.

The network security appliance requests that the user provide a second factor network authentication by causing a message to display in the network element being used by the user to request access to the network protected by the network security appliance (block 212). In some embodiments, the second factor network authentication includes a side channel authentication. For example, the side channel authentication can be an email address or phone number accessible to the user, and where the user can receive a message. This second factor network authentication allows the network security appliance to send a message to the user by the defined second factor authentication, and in turn the user can respond to a request to indicate the received message to the network security appliance. As another example, the second factor network authentication may be biometric information personal to the user. Such biometric information may include, but is not limited to, a retinal scan information, a face image, a finger print, a cardiac rhythm information, a hand print, a foot print, a voice recording, or the like. Once requested (block 212), the network security appliance awaits receipt of the second factor network authentication (block 214).

Once the network security appliance receives the second factor network authentication (block 214), the network security appliance stores the second factor network authentication (block 216). This second factor network authentication then becomes the basis by which the network security appliance will authorize network access in the future.

The network security appliance requests that the user provide a third factor network authentication by causing a message to display in the network element being used by the user to request access to the network protected by the network security appliance (block 218). In some embodiments where the second factor network authentication was a side channel authentication, the third factor authentication is biometric information personal to the user. In other embodiments where the second factor network authentication was biometric information personal to the user, the third factor authentication is a side channel authentication. Once requested (block 218), the network security appliance awaits receipt of the second factor network authentication (block 220).

Once the network security appliance receives the third factor network authentication (block 220), the network security appliance stores the third factor network authentication (block 222). This third factor network authentication then becomes the basis by which the network security appliance will authorize network access in the future.

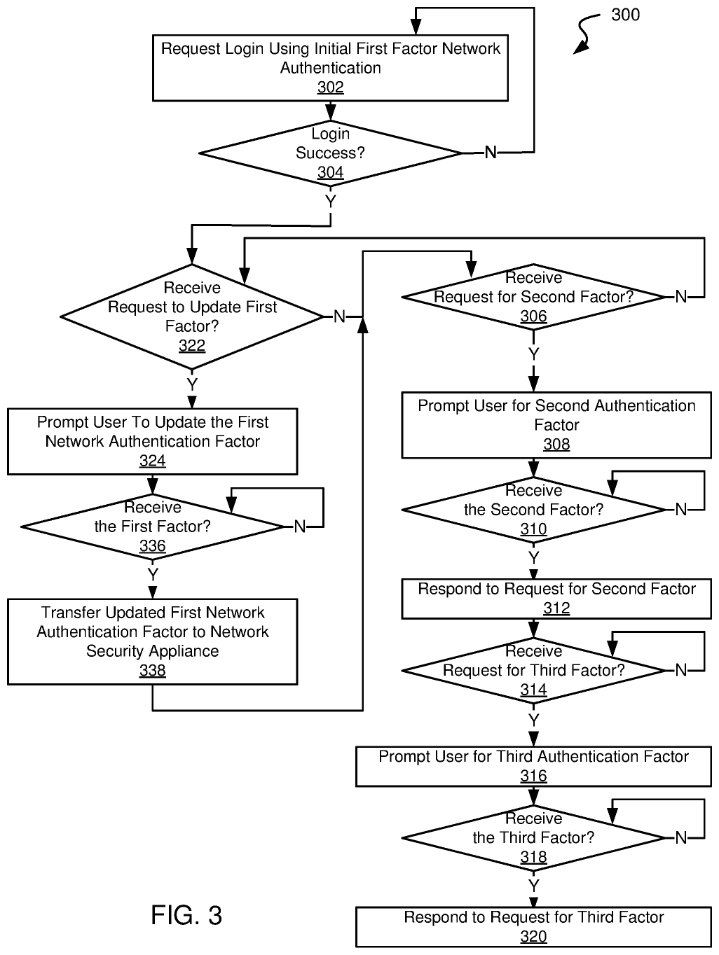

Turning to FIG. 3, a flow diagram 300 shows a method in accordance with various embodiments for initializing a three part authentication including biometric information on an accessing network element. Following flow diagram 300, access to a network is initially requested by a user using a network element (block 302). This initial request to access the network includes providing an initial first factor network authentication to a network security appliance protecting access to the network. In some embodiments, this initial first factor network authentication is a username and a temporary password assigned to a user by a network administrator overseeing the network. Based upon the disclosure provided herein, one of ordinary skill in the art will recognize a variety of other authentication factors that may be used as the first factor network authentication. The initial first factor network authentication is provided to the aforementioned user.

Having provided the initial first factor network authentication from the network element used by the aforementioned user to the network appliance protecting the network to be accessed (block 302), the network element awaits a response (block 304). Where the network appliance provides a response granting access to the network (i.e., a login success)(block 304), it is determined whether the network security appliance has requested a modification to the initial first network authentication factor (block 322). Where a request to modify the initial first network authentication factor had been received (block 322), the user is prompted to update the initial first network authentication factor (block 324). Where, for example, the initial first network authentication factor is a username and a temporary password, the user may be prompted to select a password of their choosing. Once the updated first network authentication factor is received (block 336), the updated first network authentication factor is communicated from the network element to the network security appliance (block 338). This updated first factor network authentication then becomes the basis by which the user will access the network via the network security appliance in the future.

Where either a request to update the initial first network authentication factor is not received from the network security appliance (block 322) or the initial first network authentication factor has been updated and provided to the network security appliance (block 338), it is determined whether a request for a second network authentication factor has been received (block 306). Where such a request has been received (block 306), the user is prompted to provide a second network authentication factor (block 308). In some embodiments, the second factor network authentication includes a side channel authentication. For example, the side channel authentication can be an email address or phone number accessible to the user, and where the user can receive a message. This second factor network authentication allows the network security appliance to send a message to the user by the defined second factor authentication, and in turn the user can respond to a request to indicate the received message to the network security appliance. As another example, the second factor network authentication may be biometric information personal to the user. Such biometric information may include, but is not limited to, a retinal scan information, a face image, a finger print, a cardiac rhythm information, a hand print, a foot print, a voice recording, or the like. Once requested (block 308), the network element awaits receipt of the second factor network authentication from the user (block 310). Where the second network authentication factor is a side channel authentication, the user selects the side channel information via a user input interfaced associated with the network element. Alternatively, where the second network authentication factor is biometric information, the user provides the biometric information via a biometric information interface communicably coupled to the network element.

Once the network element receives the second factor network authentication (block 310), the network element responds to the request from the network security appliance for the second network authentication factor by providing the second factor network authentication received from the user to the network security appliance (block 312). This second factor network authentication then becomes the basis by which the user will access the network via the network security appliance in the future.

It is determined whether a request for a third network authentication factor has been received (block 314). Where such a request has been received (block 314), the user is prompted to provide a third network authentication factor (block 316). In some embodiments where the second factor network authentication was a side channel authentication, the third factor authentication is biometric information personal to the user. In other embodiments where the second factor network authentication was biometric information personal to the user, the third factor authentication is a side channel authentication. Once prompted (block 316), the network element awaits receipt of the third factor network authentication from the user (block 318).

Once the network element receives the third factor network authentication (block 318), the network element responds to the request from the network security appliance for the third network authentication factor by providing the third factor network authentication received from the user to the network security appliance (block 320). This third factor network authentication then becomes the basis by which the user will access the network via the network security appliance in the future.

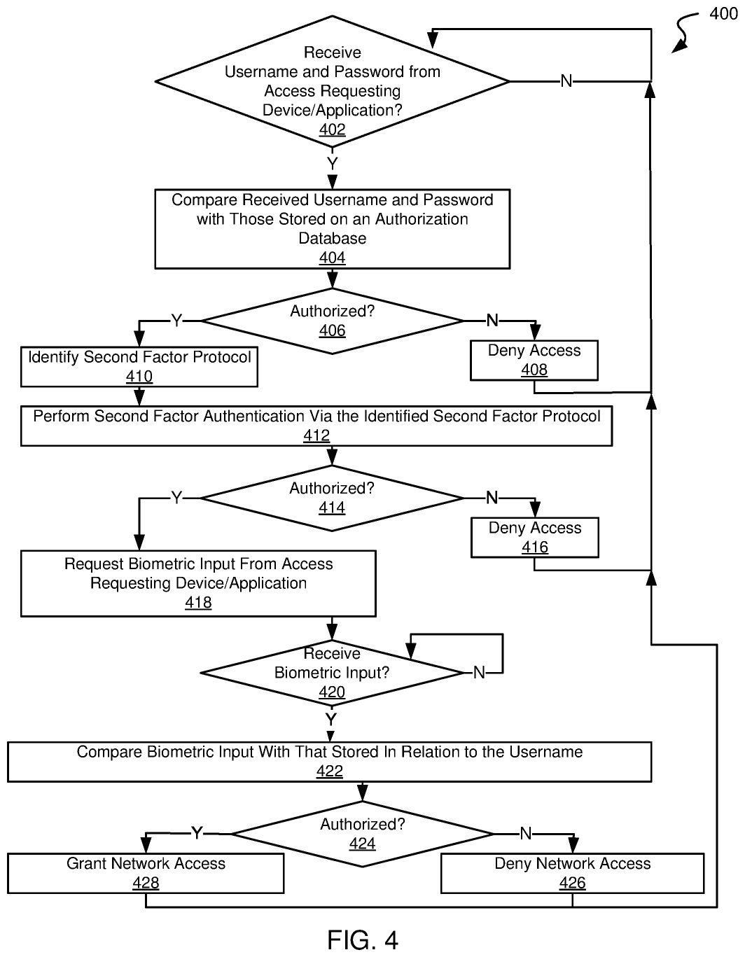

Turning to FIG. 4, a flow diagram 400 shows a method in accordance with some embodiments for authorizing network access by a network security appliance using a three part authentication including biometric information. Following flow diagram 400, it is determined by the network security appliance whether it has received a first network authentication factor in the form of a username and password as part of a request for authorization to access a network protected by the network security appliance (block 402). Where the username and password has been received (block 402), the received username and password are compared with those stored in a database maintained in relation to the network security appliance to determine a match (block 404). Where no match is found to the provided username and password (block 404), network access is not authorized (block 406) and access is denied (block 408). Such denial of access may include, but is not limited to, communicating an access denial to a network element that provided the username and password.

Alternatively, where a match is found to the provided username and password (block 404), network access is authorized (block 406) and a second network authentication factor associated with the authorized username and password is identified (block 410). This identification of the second network authentication factor may include accessing a database maintained in relation to the network security appliance to find the second network authentication factor that is stored in relation to the aforementioned username and password.

While in this embodiment the second network authentication factor is a side channel authentication, one of ordinary skill in the art will recognize a variety of other authentication processes that may be used as the second network authentication factor. As an example, the side channel authentication used as the second network authentication factor can be an email address or phone number accessible to the user, and where the user can receive a message. The network appliance uses the identified second network authentication factor (i.e., the identified side channel) to send a message to the identified side channel as part of performing second factor authentication (block 412). In turn, the network security appliance awaits a response to the message sent to the identified side channel (e.g., a token included in the message that was sent to the side channel). Once received, the network security appliance determines whether the received input matches that required by the message that was sent to determine whether access will be authorized (block 414). Where the received response input is not correct network access is not authorized (block 414), and access is denied (block 416). Such denial of access may include, but is not limited to, communicating an access denial to a network element that provided the username and password.

Alternatively, where the response received in performing the second network authentication factor authentication results in authorization to access the network (block 416), a biometric information is requested from the user via the network element being used by the user (block 418) and the network security appliance awaits transfer of the requested biometric information from the user via the network element (block 420). Such biometric information may include, but is not limited to, a retinal scan information, a face image, a finger print, a cardiac rhythm information, a hand print, a foot print, a voice recording, or the like. Based upon the disclosure provided herein, one of ordinary skill in the art will recognize a variety of biometric information that may be used in relation to different embodiments.

The received biometric information is compared with that accessed from a database maintained in relation to the network security appliance (block 422). In some cases, sample biometric information was collected during an initiation processed and stored in the database in relation to the username and password for the same individual. This comparison biometric information can be later retrieved from the database and compared with the newly received biometric information to determine if network access is to be authorized (block 424). Where no match is found between the comparison biometric information and the newly received biometric information (block 422) and therefore network access is not authorized (block 424), network access is denied (block 426). Such denial of access may include, but is not limited to, communicating an access denial to a network element that provided the username and password. Alternatively, where a match is found between the comparison biometric information and the newly received biometric information (block 422) and therefore network access is authorized (block 424), network access is granted (block 428).

It is noted that in the embodiment the second network authentication factor is processed before the biometric information. However, based upon the disclosure provided herein, one of ordinary skill in the art will recognize that in other embodiments the biometric information may be processed prior to performing the second network authentication factor authentication.

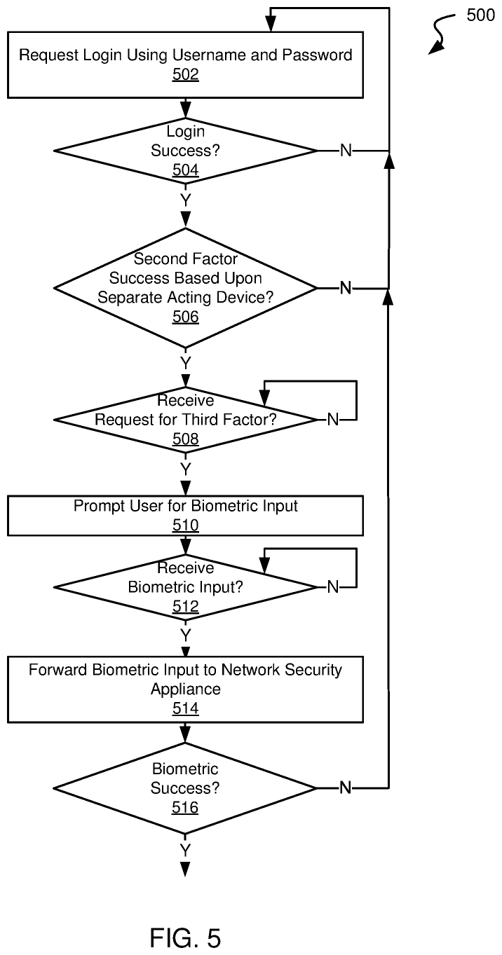

Turning to FIG. 5 is a flow diagram 500 shows a method in accordance with some embodiments for performing network access by an accessing network element using a three part authentication including biometric information. Following flow diagram 500, a network element requests access to a network by providing a username and password to a network security appliance protecting the network (block 502). It is determined whether the provided username and password resulted in authorization (block 504). This is determined by the network element based upon feedback provided from the network security device. For example, where the login was not authorized (block 504), a denial message may be provided by the network security device to the network element. Alternatively, where the login was authorized (block 504), it may be indicated by the network security element requesting input in relation to a second network authentication factor processing. Such second factor network authentication may be performed via a side channel such as, for example, an email link or a mobile phone link.

It is determined whether processing of the second network authentication factor resulted in access authorization (block 506). Where it did result in network access authorization (block 506), the network element awaits a request from the network security appliance for a third network authentication factor (block 508). Where a request is received for the third network authentication factor (block 508), the network element prompts the user to enter requested biometric information (block 510). Such biometric information may include, but is not limited to, a retinal scan information, a face image, a finger print, a cardiac rhythm information, a hand print, a foot print, a voice recording, or the like. Based upon the disclosure provided herein, one of ordinary skill in the art will recognize a variety of biometric information that may be used in relation to different embodiments. The user enters the requested biometric information using a biometric capture interface associated with the network element.

Once the biometric information is received from the user (block 512), the network element provides the received biometric information to the network security appliance (block 514). The network element awaits an indication as to whether the network security appliance granted network access based upon the provided biometric information (block 516). It is noted that in the embodiment the second network authentication factor is processed before the biometric information. However, based upon the disclosure provided herein, one of ordinary skill in the art will recognize that in other embodiments the biometric information may be processed prior to performing the second network authentication factor authentication.

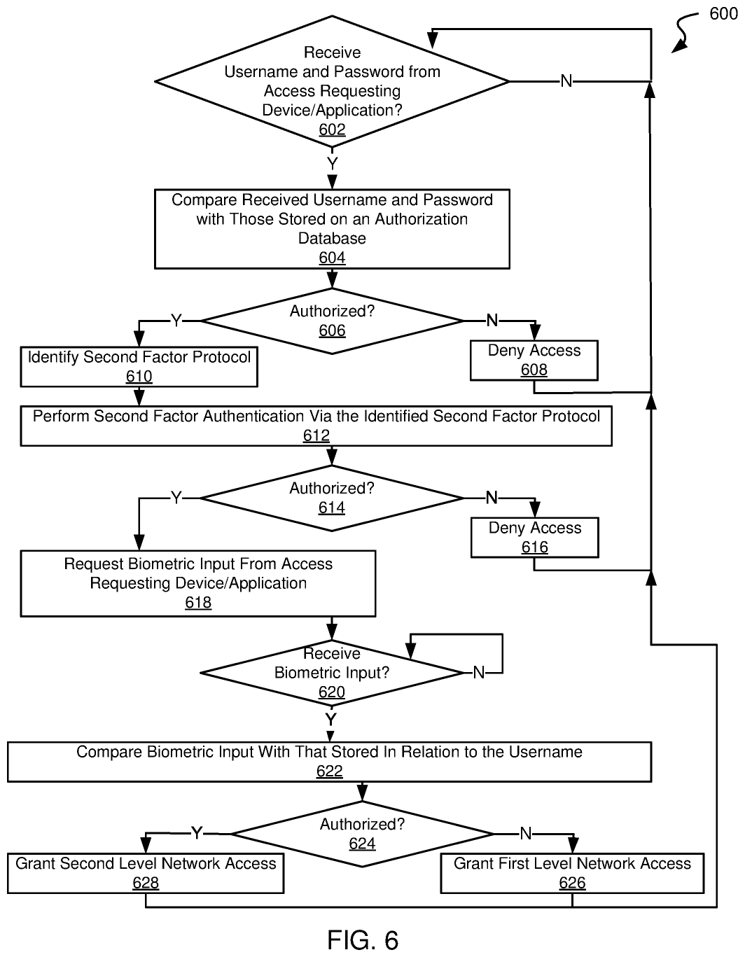

Turning to FIG. 6, a flow diagram 600 shows a method in accordance with some embodiments for two tiered network authorization by a network security appliance using a three part authentication including biometric information. Following flow diagram 600, it is determined by the network security appliance whether it has received a first network authentication factor in the form of a username and password as part of a request for authorization to access a network protected by the network security appliance (block 602). Where the username and password has been received (block 602), the received username and password are compared with those stored in a database maintained in relation to the network security appliance to determine a match (block 604). Where no match is found to the provided username and password (block 604), network access is not authorized (block 606) and access is denied (block 608). Such denial of access may include, but is not limited to, communicating an access denial to a network element that provided the username and password.

Alternatively, where a match is found to the provided username and password (block 604), network access is authorized (block 606) and a second network authentication factor associated with the authorized username and password is identified (block 610). This identification of the second network authentication factor may include accessing a database maintained in relation to the network security appliance to find the second network authentication factor that is stored in relation to the aforementioned username and password.

While in this embodiment the second network authentication factor is a side channel authentication, one of ordinary skill in the art will recognize a variety of other authentication processes that may be used as the second network authentication factor. As an example, the side channel authentication used as the second network authentication factor can be an email address or phone number accessible to the user, and where the user can receive a message. The network appliance uses the identified second network authentication factor (i.e., the identified side channel) to send a message to the identified side channel as part of performing second factor authentication (block 612). In turn, the network security appliance awaits a response to the message sent to the identified side channel (e.g., a token included in the message that was sent to the side channel). Once received, the network security appliance determines whether the received input matches that required by the message that was sent to determine whether access will be authorized (block 614). Where the received response input is not correct network access is not authorized (block 614), and access is denied (block 616). Such denial of access may include, but is not limited to, communicating an access denial to a network element that provided the username and password.

Alternatively, where the response received in performing the second network authentication factor authentication results in authorization to access the network (block 616), a biometric information is requested from the user via the network element being used by the user (block 618) and the network security appliance awaits transfer of the requested biometric information from the user via the network element (block 620). Such biometric information may include, but is not limited to, a retinal scan information, a face image, a finger print, a cardiac rhythm information, a hand print, a foot print, a voice recording, or the like. Based upon the disclosure provided herein, one of ordinary skill in the art will recognize a variety of biometric information that may be used in relation to different embodiments.

The received biometric information is compared with that accessed from a database maintained in relation to the network security appliance (block 622). In some cases, sample biometric information was collected during an initiation processed and stored in the database in relation to the username and password for the same individual. This comparison biometric information can be later retrieved from the database and compared with the newly received biometric information to determine if network access is to be authorized (block 624). Where no match is found between the comparison biometric information and the newly received biometric information (block 622) and therefore network access is not additionally authorized based upon the biometric information (block 624), only first tier network access is granted (block 626). Such first tier network access is limited to only a subset of less sensitive network resources. Alternatively, where a match is found between the comparison biometric information and the newly received biometric information (block 622) and therefore network access is additionally authorized based upon the biometric information (block 624), second tier network access is granted (block 628). Such second tier network access grants broader permission than the aforementioned first tier network access.

It is noted that in the embodiment the second network authentication factor is processed before the biometric information. However, based upon the disclosure provided herein, one of ordinary skill in the art will recognize that in other embodiments the biometric information may be processed prior to performing the second network authentication factor authentication.

In conclusion, the present invention provides for novel systems, devices, and methods. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims. What is claimed is:

1. A method for biometric based network access authorization, the method comprising:
receiving, by a processing resource, a first network authentication factor from a network element;
comparing, by the processing resource, the first network authentication factor with a first factor;
requesting, by the processing resource, a second network authentication factor based at least in part on the first network authentication factor matching the first factor;
requesting, by the processing resource, from the network element a biometric network authentication factor;
comparing, by the processing resource, the biometric network authentication factor with a second factor; and
granting, by the processing resource, access to a network associated with the processing resource based at least in part on a match between the biometric network authentication factor and the second factor.

2. The method of claim 1, wherein:
the biometric authentication factor is a first biometric data from a user of the network element, and wherein the first biometric data is selected from a group consisting of: a retinal scan, a face image, a finger print, a cardiac rhythm, a hand print, a foot print, and a voice recording; and
the second factor is a second biometric data previously provided by the user or the network element, and wherein the second biometric data is selected from a group consisting of: a retinal scan, a face image, a finger print, a cardiac rhythm, a hand print, a foot print, and a voice recording.

3. The method of claim 1, wherein:
the first network authentication factor is a username and password corresponding to a user of the network element.

4. The method of claim 1, wherein the second network authentication factor is a response to a question, and wherein the method further comprises:
comparing, by the processing resource, the response to the question to a previously obtained response to the question; and
wherein requesting from the network element the biometric network authentication factor is based at least in part on a match between the response to the question and the previously obtained response to the question.

5. The method of claim 1, wherein the second network authentication factor is a side channel associated with the user of the network element, and wherein the requesting the second network authentication factor includes providing a query to the user via the side channel, and wherein the method further comprises:
comparing, by the processing resource, a response to the query with an expected response; and
wherein requesting from the network element the biometric network authentication factor is based at least in part on a match between the response to the query and the expected response.

6. The method of claim 5, wherein the side channel is selected from a group consisting of: an email of the user, and a phone number of the user.

7. The method of claim 1, wherein the second network authentication factor is a response to a question, and wherein the method further comprises:
comparing, by the processing resource, the response to the question to a previously obtained response to the question;
wherein requesting the second network authentication factor is based at least in part on both (a) the first network authentication factor matching the first factor, and (b) the biometric network authentication factor matching the second factor; and
wherein granting access to the network associated with the processing resource si based at least in part on both (a) a match between the biometric network authentication factor and the second factor, and (b) a match between the response to the question and the previously obtained response to the question.

8. The method of claim 1, wherein the second network authentication factor is a side channel associated with the user of the network element, and wherein the requesting the second network authentication factor includes providing a query to the user via the side channel, and wherein the method further comprises:
comparing, by the processing resource, a response to the query with an expected response;
wherein requesting from the network element the biometric network authentication factor is based at least in part on both (a) a match between the response to the query and the expected response, and (b) a match between the biometric network authentication factor and the second factor; and
wherein granting access to the network associated with the processing resource si based at least in part on both (a) a match between the biometric network authentication factor and the second factor, and (b) a match between the response to the question and the previously obtained response to the question.

9. A network security appliance, the network security appliance comprising:
a processing resource;
a non-transitory computer-readable medium, coupled to the processing resource, having stored therein instructions that when executed by the processing resource cause the processing resource to:
receive a first network authentication factor from a network element;
compare the first network authentication factor with a first factor;
request a second network authentication factor based at least in part on the first network authentication factor matching the first factor;
request from the network element a biometric network authentication factor;
compare the biometric network authentication factor with a second factor; and
grant access to a network associated with the processing resource based at least in part on a match between the biometric network authentication factor and the second factor.

10. The network security appliance of claim 9, wherein:
the biometric authentication factor is a first biometric data from a user of the network element, and wherein the first biometric data is selected from a group consisting of: a retinal scan, a face image, a finger print, a cardiac rhythm, a hand print, a foot print, and a voice recording; and
the second factor is a second biometric data previously provided by the user or the network element, and wherein the second biometric data is selected from a group consisting of: a retinal scan, a face image, a finger print, a cardiac rhythm, a hand print, a foot print, and a voice recording.

11. The network security appliance of claim 9, wherein:
the first network authentication factor is a username and password corresponding to a user of the network element.

12. The network security appliance of claim 9, wherein the second network authentication factor is a response to a question, and wherein the non-transitory computer-readable medium further has stored therein instructions that when executed by the processing resource cause the processing resource to:
compare the response to the question to a previously obtained response to the question; and
wherein requesting from the network element the biometric network authentication factor is based at least in part on a match between the response to the question and the previously obtained response to the question.

13. The network security appliance of claim 9, wherein the second network authentication factor is a side channel associated with the user of the network element, and wherein the requesting the second network authentication factor includes providing a query to the user via the side channel, and wherein the non-transitory computer-readable medium further has stored therein instructions that when executed by the processing resource cause the processing resource to:
compare a response to the query with an expected response; and
wherein requesting from the network element the biometric network authentication factor is based at least in part on a match between the response to the query and the expected response.

14. The network security appliance of claim 13, wherein the side channel is selected from a group consisting of: an email of the user, and a phone number of the user.

15. The network security appliance of claim 9, wherein the second network authentication factor is a response to a question, and wherein the non-transitory computer-readable medium further has stored therein instructions that when executed by the processing resource cause the processing resource to:
compare the response to the question to a previously obtained response to the question;
wherein requesting the second network authentication factor is based at least in part on both (a) the first network authentication factor matching the first factor, and (b) the biometric network authentication factor matching the second factor; and
wherein granting access to the network associated with the processing resource si based at least in part on both (a) a match between the biometric network authentication factor and the second factor, and (b) a match between the response to the question and the previously obtained response to the question.

16. The method of claim 1, wherein the second network authentication factor is a side channel associated with the user of the network element, and wherein the requesting the second network authentication factor includes providing a query to the user via the side channel, and wherein the non-transitory computer-readable medium further has stored therein instructions that when executed by the processing resource cause the processing resource to:
compare the response to the query with an expected response;
wherein requesting from the network element the biometric network authentication factor is based at least in part on both (a) a match between the response to the query and the expected response, and (b) a match between the biometric network authentication factor and the second factor; and
wherein granting access to the network associated with the processing resource si based at least in part on both (a) a match between the biometric network authentication factor and the second factor, and (b) a match between the response to the question and the previously obtained response to the question.

17. A computer readable medium having stored therein instructions that when executed by a processing resource cause the processing resource to:
receive a first network authentication factor from a network element;
compare the first network authentication factor with a first factor;
request a second network authentication factor based at least in part on the first network authentication factor matching the first factor;
request from the network element a biometric network authentication factor;
compare the biometric network authentication factor with a second factor; and
grant access to a network associated with the processing resource based at least in part on a match between the biometric network authentication factor and the second factor.

18. The computer readable medium of claim 17, wherein:
the biometric authentication factor is a first biometric data from a user of the network element, and wherein the first biometric data is selected from a group consisting of: a retinal scan, a face image, a finger print, a cardiac rhythm, a hand print, a foot print, and a voice recording; and
the second factor is a second biometric data previously provided by the user or the network element, and wherein the second biometric data is selected from a group consisting of: a retinal scan, a face image, a finger print, a cardiac rhythm, a hand print, a foot print, and a voice recording.

19. The computer readable medium of claim 17, wherein:
the first network authentication factor is a username and password corresponding to a user of the network element.

20. The computer readable medium of claim 17, wherein the second network authentication factor is a side channel associated with the user of the network element, and wherein the requesting the second network authentication factor includes providing a query to the user via the side channel, and wherein the non-transitory computer-readable medium further has stored therein instructions that when executed by the processing resource cause the processing resource to:
compare a response to the query with an expected response;
wherein requesting from the network element the biometric network authentication factor is based at least in part on a match between the response to the query and the expected response.
